(19) United States
(12) Patent Application Publication
(10) Pub. No.: US 2026/0176962 A1
(43) Pub. Date: Jun. 25, 2026

(54) Method for intervening on a ground drilling apparatus; device functionally connected to a ground drilling apparatus; computer-readable storage medium and ground drilling apparatus

(71) Applicant: TRACTO-TECHNIK GmbH & Co. KG, Lennestadt (DE)

(72) Inventors: Elmar Koch-Gast, Eslohe (DE); Carola Bilgen, Kirchhundem (DE); Gerhard Völkel, Erndtebrück (DE); Tobias Klein, Attendorn (DE); Marku Hamers, Lennestadt (DE)

(73) Assignee: TRACTO-TECHNIK GmbH & Co. KG, Lennestadt (DE)

(21) Appl. No.: 19/423,152

(22) Filed: Dec. 17, 2025

(30) Foreign Application Priority Data
Dec. 20, 2024 (DE) 10 2024 139 374.2

(51) Int. Cl. E21B 47/024; E21B 7/04; G08B 21/18

(52) U.S. Cl. CPC E21B 47/024; E21B 7/04; G08B 21/182

(57) ABSTRACT

The invention relates to a method for intervening on a ground drilling apparatus that is configured to introduce a borehole by moving a drill string comprising rod sections from a starting location to a target location, wherein the method comprises the method step of determining a bending radius of a section of the drill string during the introduction of the borehole and intervening on the ground drilling apparatus depending on the magnitude of the bending radius of the section of the drill string during the introduction of the borehole.

### FIELD OF THE INVENTION

The invention relates to a method for intervening on a ground drilling apparatus, to a device functionally which is connected to a ground drilling apparatus, to a computer-readable storage medium and to a ground drilling apparatus.

### PRIOR ART

It is known to use ground drilling apparatuses to introduce drill holes or boreholes in the ground.

Obstacles in the area of the borehole to be created pose a problem, as obstacles such as water, gas, electricity, signal and/or other lines or conduits must be avoided. The maneuvering to avoid obstacles, especially unknown ones, and still reach the target, regularly places a strain on a drill string comprising rod sections.

From EP 3 690 185 B1 it is known to detect bending loads of the drill string in order to improve a service life calculation of a rod section and/or to increase the operational reliability of a ground drilling apparatus, wherein the load is not determined at the drive apparatus in particular, but is determined in the drill hole or in the borehole itself by detecting a course of the drill hole, in particular a curved area of the drill hole. EP 3 690 185 B1 aims to determine the service life of the rod section in order to replace it before the end of its service life or before it breaks.

### SUMMARY OF THE INVENTION

The object of the invention is to safely introduce a borehole, to conserve resources and/or to efficiently create or introduce the borehole.

The core idea of the invention is to pursue the previously unconsidered approach of intervening on the ground drilling apparatus depending on the stress on the drill string, in order to keep the load on the drill string within such a range that an adjustment confirmed and changed by the operator and/or changed by the ground drilling apparatus occurs, with the aim of exerting only a slight (manageable) overload or even virtually no overload on the drill string. The invention thus takes a different approach than EP 3 690 185 B1, in which the stress on the drill string is merely noted and a service life calculation is carried out for the individual rod section.

The invention has recognized for the first time that the approach of intervening on the ground drilling process even during the creation of a planned borehole represents a departure from the mere determination of the service life calculation, and offers the possibility of using the rod sections for longer and/or introducing the borehole more efficiently, which represents a significant added value for the operator of a ground drilling apparatus.

The object is achieved by the subject matters of the independent claims. Advantageous embodiments are the subject matter of the respective dependent claims and the description.

### GENERAL DESCRIPTION

The invention provides a method for intervening on a ground drilling apparatus configured to introduce a borehole by moving a drill string comprising rod sections from a starting location to a target location. The method comprises the method step of determining a bending radius of a section of the drill string during the introduction of the borehole. Furthermore, the ground drilling apparatus is intervened on depending on the magnitude of the bending radius of the section of the drill string during the introduction of the borehole.

Within the meaning of the description, the term “ground drilling apparatus” encompasses a (and thus any) device configured to move a drill string comprising rod sections in a borehole in the ground. The ground drilling apparatus can in particular be an HD device or an HDD device. In directional drilling, the direction of the drill head can be changed, allowing for a curvature of the borehole, which in turn causes a curvature of the drill string. A ground drilling apparatus can be an apparatus that drives a drill string, which works to displace the ground and introduces the drill string into the ground in a translational and/or rotational manner in the longitudinal axial direction of the drill string. An additional rotational movement of the drill string around the longitudinal axis may be provided.

The borehole is usually introduced into the ground, whereby the term “ground” is to be understood broadly within the meaning of the description and can include any material. The ground can include any type of soil, such as sand and/or earth, solid or loose rock and/or bedrock. The material of the soil in which the borehole is introduced can change along the length of the borehole. Mixed earth types, in the sense of a combination of materials, for example in the form of sand and stone or rock, are possible.

The term “borehole” encompasses, within the meaning of the description, the course of a borehole. Within the meaning of this description, the borehole can be an existing borehole or a borehole to be created, which s preferably at least partially horizontal, so that the term “introducing a borehole” within the meaning of the description can include both a borehole newly introduced in the ground and an enlargement of a borehole already existing in the ground. In particular, when reaming an existing borehole in the ground, at least one pipeline and/or at least one other long body can be inserted into the ground. In particular, the borehole can be planned and the ground drilling apparatus configured to introduce the borehole according to the plan. The planning of a borehole includes planning a trajectory for the drill string between the starting location and the target location, taking into account any known obstacles in the ground.

If it is described that the term “introducing a borehole” also includes reaming an existing borehole, then it is self-evident that removing a drill string that was initially introduced into the ground from the ground can also be classified as “introducing a borehole.” This is particularly relevant given that, after the target location has been reached for the first time, preferably in connection with a pilot borehole, a reaming process usually occurs when the drill string is removed from the ground. Before reversing the direction of movement, especially at the target location, a drilling tool provided at the end of the drill string for the pilot bore can be replaced by a reaming tool, so that the previously created pilot bore can be reamed from the target location to the starting location.

It goes without saying that the term “introducing a borehole” also includes removing the drill string from the ground without reaming, since the drill string-even without reaming-must be removed from the borehole to be created, otherwise there is logically no “free” borehole.

The term “starting location” encompasses, within the meaning of the description, a position from which a drilling operation for the introduction of a borehole can be started using the ground drilling apparatus. Typically, the starting location is a launch pit from which the ground drilling apparatus inserts the drill string into the ground.

The term “target location” within the meaning of the description encompasses a position to which the drill string is to be moved in order to create the borehole. Typically, the target location is a target pit from which the drill string can exit the borehole, particularly the ground, into the open air.

Within the meaning of the description, the term “rod section” includes not exclusively rigid, individual force transmission elements which can be connected to one another indirectly or directly and which can be used in a ground drilling apparatus. A rod section may be subjected to bending during the introduction of the borehole. A rod section can be in particular rod-shaped. A rod section can have a connection option, particularly at one end, and most preferably at both ends, by means of which two rod sections can be connected to each other. In particular, the connection option can be a screw thread, part of a plug connection or another mechanical means of engagement. The connection option can also be a combination of multiple mechanical intervention options.

The rod sections can be connected together to form a drill string comprising rod sections. The connection can be lengthened depending on the drilling progress (especially in the case of a pilot bore) or shortened after the end of the drilling (when pulling out and removing the drill string from the ground). An extension is usually achieved by adding a rod section (to be added), which is attached to the drill string already inserted or located in the ground; the drill string extended by one rod section is then introduced further into the ground by the length of this rod section. Similarly, the drill string can be shortened, with the shortening usually being carried out by one rod section. During shortening—the pulling out of the drill string from the ground after drilling has been completed—the drill string is pulled out of the ground by the length of one rod section and the rod section is separated from the drill string that remains in the ground.

The rod sections can be double-tube rod sections, which may have an inner rod section and an outer rod section surrounding the inner rod section.

The drill string may have a drill head at one end, particularly at the front, and, if present, a drill head tip. The drill string can have a front-facing drill tool which can be replaced, in particular when creating the borehole at the target location, especially to be replaced by a reaming tool with which reaming can be achieved when reversing the direction of movement of the drill string.

Depending on its design and (material) stiffness, inter alia, the rod section may have a minimum bending radius, which is usually specified by the manufacturer and should not be undercut if possible, as otherwise overloading, damage to the rod section and/or a reduction in the service life of the rod section can occur. For example, a minimum bending radius of approximately 33 m can be specified for a rod section with a (usable) length of approximately 3 m and an outer diameter of approximately 7 cm. The minimum bending radius is usually referred to in the language of manufacturers and/or operators as the minimum “permissible” bending radius.

The term “moving the drill string” includes, in particular, a pushing movement of the drill string. In particular, when creating a first drill hole (introducing a borehole as a pilot borehole), the drill string is inserted or pressed into the ground. When the drill string is pulled out, which can usually be accompanied by a reaming of the borehole (the drill head may be replaced by a reaming tool), the drill string can be pulled through the ground (following the borehole). The pulling or pushing movement can be supported by rotating the drill string.

A drive apparatus is usually provided to impart the movement intended for introducing the borehole to the drill string. The drive apparatus, as described, comprises a drive by means of which the drive forces or drive movements are transmitted to the drill string. In a preferred embodiment, the drive apparatus can be configured as a linear drive. The drive can also be configured as a rack and pinion drive. The drive apparatus can have hydraulic cylinders as a drive.

The term “determining the bending radius of a section of the drill string” encompasses, within the meaning of the description, a wide variety of methods for measuring or determining the bending radius. Concerning the magnitude of the bending radius, the terms “determine,” “detect,” “measure” and “ascertain” are used synonymously. The interchangeability of the aforementioned terms takes into account the fact that, as with the determination of a length, a standard cannot usually be applied to the quantity to be measured, but rather an evaluation can be carried out in which a measurement/determination of possibly multiple quantities and/or signals is taken into account in order to determine the bending radius.

The “determination of a bending radius of a section of the drill string” can be determined from the data of the borehole. It is possible, for example, that the position of the drill head or the position of another section of the drill string is continuously or discontinuously detected during the introduction of the borehole and the bending radius is calculated using the given data. For example, the positions of the drill head can be used to determine the positions, points, or locations of the borehole that the drill head, and thus also the drill string following the drill head, passes through. It is possible to determine the position of the drill head or another section of the drill string continuously and/or discontinuously using a tracking system.

The tracking system could be, among other things, a tracking system commonly known in the field as a “walk-over system.” For this purpose, a transmitter arranged on the drill string, preferably at the front end of the drill string, in particular in or on the drill head, can be located by means of a search device or locating probe that can be moved above and outside the ground, and, for example, the depth of the transmitter, i.e., of the drill string, relative to the search device can be deduced from the strength of the signal of the transmitter received by the search device. Directly from the data of the walk-over system, a two-dimensional course of the borehole can be determined by calculating the depth of the transmitter. If the position of the search device is referenced or determined when the depth has been or is being determined, for example by means of a GNSS (global navigation satellite system), a 3-dimensional course of the borehole (depth plus location of the search device above the ground) can be determined. Besides the walk-over system, there are many other tracking systems that can also be combined with each other. The expert can use any of these tracking systems as an alternative or in addition. For example, location can be determined using a gyrocompass that can measure the strength of the earth's magnetic field, and/or via cable.

It may be provided that the discontinuous determination of the position of the drill string, in particular the drill head, can be carried out after drilling in a rod section of the drill string and before further insertion of the drill string extended by one rod section.

The locating system can also be used after the direction of the drill string has been reversed to determine the position of any section of the drill string, in particular the front end of the drill string. However, it can also be provided additionally or alternatively that, for example, during, preferably every, location tracking, the determined location is assigned to the number of drilled in rod sections before the reversal of direction and this information is stored, so that the respective location can be deduced from the remaining number of introduced rod sections in the borehole when moving back. This information can be helpful, especially considering that the drill head with the probe may have been replaced by a reaming tool.

Since the drill string essentially follows the previously introduced borehole after the direction of the drill string is reversed, the position of the section of the drill string whose position was previously located, in particular the front end of the drill string, can be determined from the information on how many rod sections are still in the drill string. Therefore, during the movement of the drill string after the reversal of direction, the position of a section of the drill string, in particular the drill head or the replaced reaming tool, can be determined directly via the locating system and/or indirectly via the remaining number of rod sections in the borehole.

It is possible for the bending radius to be determined in 3 dimensions or in 2 dimensions. In a 3-dimensional calculation, the load state of the rod sections can be determined in all three spatial directions. In a 2-dimensional determination, essentially a “cut” is made through a plane that connects the starting location with the target location.

The term “section of the drill string” whose bending radius is determined includes, within the meaning of the description, the radius of the drill string over its course, whereby in particular the radius over the length of a rod section in the borehole can be considered.

The term “during the introduction of the borehole” encompasses, within the meaning of the description, the period during which the drill string introduces the borehole, i.e., the drill string is in the ground. A movement of the drill string, particularly longitudinal movement, is not necessary due to the description of the condition “during the introduction of the borehole,” but it is also not excluded. It encompasses the condition in which a rod section has been drilled in, the drill string is at rest, particularly in the longitudinal axial direction, and another rod section is attached to the drill string; rotational movement is not excluded.

The term “intervention” encompasses within the meaning of the description an active, in particular targeted, intervening on the ground drilling apparatus or the means controlling the ground drilling apparatus, so that in particular the borehole and/or the settings on the ground drilling apparatus for the introduction of the borehole can be intervened on, whereby the intervention can be carried out both during pushing movements, for example during the introduction of a pilot bore, and during pulling movements, for example during (subsequent) reaming. It is possible that an intervention will only occur in one direction of movement of the drill string during the introduction of the borehole.

The term “depending on the magnitude of the bending radius of the section of the drill string” includes, within the meaning of the description, the query as to whether the determined bending radius falls below a threshold value that represents a critical magnitude of the bending radius of the section of the drill string, and in particular how far—in quantitative terms—the threshold value is undercut. The threshold value may be correlated in particular with a minimum “permissible” bending radius that a rod section should not fall below.

In principle, it can be stipulated that if the threshold value is increasingly undercut, the intervention will be stronger or carried out in a different manner.

In a preferred embodiment, the method includes the method step of assigning the bending radius of the section of the drill string to a location in the borehole. In particular, it may be possible to assign the determined bending radius to the respective locations in the borehole. This opens up the possibility that, particularly when the drill string is retracted from the borehole, if there is no longer a point in the drill string that in particular has a minimum bending radius that is not met, the settings of the parameters of the ground drilling apparatus for introducing the borehole can be adjusted to usual settings and/or the operator can be notified that there are no longer any critical bending radii. It is possible to introduce the borehole more efficiently.

Within the meaning of this description, the term “parameter” of the ground drilling apparatus for introducing the borehole includes in particular a quantity set on the ground drilling apparatus in the form of the torque, tensile force and/or thrust force exerted on the drill string. If the plural is used for the term “parameter,” this includes the possibility that only one of the mentioned quantities can be changed by the intervention; a change of multiple quantities/parameters is not excluded.

The invention has identified one way of intervening, namely that, for example, in the case of a rod section with a usable length of approximately 3 m, an outer diameter of approximately 7 cm and a minimum permissible bending radius of approximately 33 m, the rod section can be “protected” if the torque does not exceed approximately 4,550 Nm and/or the maximum tensile/thrust force does not exceed approximately 130 kN. The example values for the parameters can be determined as described in the description.

In a preferred embodiment, the method includes the method step that the intervention on the ground drilling apparatus comprises issuing a warning concerning the magnitude of the bending radius of the section of the drill string at an output device. The operator is informed about the magnitude of the bending radius by the warning, whereby the warning can be a mere warning. Additionally or alternatively, the warning may include information about the magnitude of the bending radius.

The term “output device” within the meaning of the description includes an electronic or electrical device, in particular in the form of a screen, display, monitor or the like, which may be an electrically controlled display for the reproduction of information such as images or characters. It is possible that the electronic or electrical device could be a loudspeaker or signal transmitter. The output device can be part of an HMI (human-machine interface). In particular, the output device can be part of the HMI for controlling the ground drilling apparatus.

The term “warning” encompasses a notification that can be visual, audible and/or haptic. The operator can be informed via one of the sensory impressions that a warning exists regarding the magnitude of the determined bending radius.

The issuance of the warning may be accompanied by a “stopping of the introduction of the borehole,” so that the ground drilling apparatus stops any further movement of the drill string, in particular any pushing movement. Stopping the introduction of the borehole can be achieved i) by preventing the advance of the ground drilling apparatus, ii) by switching off the ground drilling apparatus and/or iii) by putting the ground drilling apparatus into a standby mode in which the ground drilling apparatus is still switched on, but no advance takes place.

In a preferred embodiment, the method includes the method step that the intervention further includes querying an input by means of which the warning can be acknowledged, and if the acknowledgment has been successful, further drilling is carried out. This can open up the possibility that a rod section, especially close to the target location, has a bending radius which, due to the location close to the target location, is only briefly and, for example, only slightly below the minimum bending radius.

The term “acknowledgment” within the meaning of the description includes an input by an operator that can be used to determine that an operator has reacted to the displayed shutdown warning in such a way that he or she has had to take note of it or has approved it. An “acknowledgment” as described can represent a security question that can only be answered by selected operators. In order to answer the security question or to make the corresponding entry, the aspect of “knowledge” and/or the aspect of “possession” can be used. An “acknowledgment” can be a qualified input that cannot be accidental, careless and/or unintentional. The acknowledgment can ensure that a) no random person acknowledges the warning and/or b) the warning is not acknowledged accidentally. Two-factor authentication is possible.

In a preferred embodiment, acknowledgment is effected by means of an alphanumeric input, a key input and/or the actuation of one or more actuating elements. It is also possible to have an acknowledgment carried out via an external (e.g. mobile) device (e.g. by a supervisor) after the supervisor has received a warning, for example via a cloud or SMS, etc. This allows the magnitude of the threshold for unintentional acknowledgment to be set. For example, the necessary alphanumeric input for acknowledgment is only known to certain operators, or is only made known to them, whereby there is a possibility that the alphanumeric input can be passed on to third parties without logging and/or without this being traceable. It may be provided that different operators or different operator groups are assigned an alphanumeric input, so that it can be traced which operator or operator group gave the acknowledgment in the form of the alphanumeric input. The same applies to a mechanical or electromagnetic key (e.g. a code card) that may be issued to a specific operator or group of operators. The same applies to the actuation of one or more actuating elements, which, for example, must be actuated in a specific sequence. When actuating multiple actuating elements, it may also be necessary that the actuating elements be actuated at least partially simultaneously. The method of actuating multiple actuating elements can only be communicated to a specific operator or operator group, so that it can be traced and logged which operator or operator group performed the acknowledgment.

As indicated above, the threshold level for inadvertent acknowledgment can be set. In accordance with the exemplary acknowledgment mentioned above, other forms of acknowledgment may also be possible. For example, biometric input may also be possible for acknowledgment, either additionally or alternatively, whereby the biometric input can correspond to a key input. For example, it may be possible to recognize a fingerprint, a face or an iris, provided a suitable reading or input device is available. Key entry and biometric entry can be seen as an acknowledgment using a code that is in possession.

It may be provided that, analogous to the aforementioned exemplary alphanumeric input, a pattern or a graphic sequence of lines can be entered alternatively or additionally, whereby the input of a pattern or a graphic sequence of lines can correspond analogously to the input of an alphanumeric input. Alphanumeric input and the input of a pattern or a graphic sequence of lines can be seen as acknowledgment by means of a code that has been made known to one (aspect “knowledge”).

Alternatively or additionally, it is also possible to present an image code to an image reader in order to trigger an acknowledgment, which can be seen as analogous to key input. Image input or the input of an image code can also be seen as acknowledgment using the aspect of “possession.”

In a preferred embodiment, the method includes the method step that the intervention causes a reversal of the introduction movement towards the starting location, in particular a, especially at least partial, pulling out of the drill string in order to introduce a modified borehole to the target location from a location of the borehole closer to the starting location. This opens up the possibility of introducing a borehole that ideally has no “critical” bending radius for the rod sections. It may be provided that the course of a borehole can be planned by means of the ground drilling apparatus or the control system of the ground drilling apparatus and/or by means of another computing unit functionally connected to the ground drilling apparatus; in particular, it may be provided that a modification of the originally planned borehole can be carried out while maintaining the target location, especially in the event of an unexpected obstacle appearing in the course of the originally planned borehole.

In a preferred embodiment, the method comprises the method step that the intervention includes a display of one or more suggestions concerning the magnitude of parameters of the operation of the ground drilling apparatus that can be used to introduce the borehole depending on the magnitude of the bending radius of the section of the drill string and/or the intervention includes a setting of parameters of the ground drilling apparatus that are used to introduce the borehole depending on the magnitude of the bending radius of the section of the drill string. Suggestions for parameters, which may include in particular the torque exerted or applied by the ground drilling apparatus to the drill string, the thrust force exerted and the tensile force exerted, can be displayed to the operator and they can select from the suggestions. It is also possible that the method can perform an automatic selection, at least temporarily and/or optionally, in which the operator is not involved or does not need to be involved. This can open up the possibility of supporting the operator, if necessary, especially if it is possible to set the parameters accordingly, to introduce the borehole without potentially damaging the rod section. The operator can receive added value in the form of indirect support from the display of the suggestion(s). If this is not desired, the method itself can be used to intervene on the setting of the parameters of the ground drilling apparatus, so that the operator can be fully supported by an automatic process without having to carry out any intervention himself/herself. In the “automatic variant,” the operator can be informed about the selected parameters, i.e., those automatically set by means of the intervention.

In a preferred embodiment, the method includes the method step—when a suggestion or multiple suggestions are displayed—of requesting input regarding the selection of the suggestion or a selection from the multiple suggestions. This opens up the possibility of achieving a simple representation of a selection that can be perceived by the operator in order to select it. The operator can, for example, select whether a gentler or a faster drilling process is desired. The operator also has the option to cancel the selection, for example to stop further introduction of the borehole.

In a preferred embodiment, the method includes the method step of determining the magnitude of the parameters by means of a calculation, an estimation and/or using artificial intelligence. This opens up the possibility of identifying a suitable alternative and using appropriate determination methods for selecting the parameters.

In principle, a person skilled in the art can essentially calculate the load on the drill string, and in particular the load on a section of the drill string which may correspond to a rod section, analytically. For this purpose, the quantities exerted on the drill string by the ground drilling apparatus, such as tension, pressure or torque, and the bending radius to which the drill string or the rod section is subjected, are determined. The stresses for torsion, tension/pressure and bending can be calculated using the outer diameter, the inner diameter, the thrust force/tensile force, the torque and the bending moment. The calculated bending stress takes into account the determined bending radius, and a relationship can be established between the bending radius and the torque or tensile/compressive force. Corresponding formulas can be established for the torque and the tensile/compressive force, whereby a comparative stress can be calculated.

It is possible that the formulas for torque and the tensile/compressive force can be approximated by linearizations or changes to the factors. Forms of functions for torque and tensile/compressive force can be selected as a function of the bending radius.

The essentially analytical formulas make it possible, if a threshold value for the minimum permissible bending radius is undershot, to set the values for the parameters of the torque and/or the compressive/tensile force exerted by the ground drilling apparatus on the drill string in such a way that the torque and/or the compressive/tensile force is/are reduced in order to obtain a constant equivalent stress. The reduction of the compressive/tensile force or the torque can be implemented using a type of step function.

The invention also provides a device that is functionally connected to a ground drilling apparatus, wherein the ground drilling apparatus is configured to introduce a borehole by moving a drill string comprising rod sections, wherein the device is configured to receive the bending radius of a section of the drill string. Furthermore, the device is configured to intervene on the ground drilling apparatus depending on the magnitude of the bending radius of the section of the drill string. This could open up the possibility of providing a device that can implement the method described in the description.

If the device is described as being configured to receive the bending radius of a section of the drill string, then the term “receive” includes active querying or passive acquisition of a signal that correlates with the magnitude of the bending radius. The device can evaluate the signal.

The term “functionally connected” encompasses, within the meaning of the description, an interaction in which signals and/or electricity can be transmitted from the device to the ground drilling apparatus. In particular, the device can transmit signals and/or electricity to the control system of the ground drilling apparatus in order to intervene on the control system of the ground drilling apparatus. The “functional connection” can also be bidirectional. Signals can be exchanged between the aforementioned entities in order to interact. The device can intervene on the ground drilling apparatus by transmitting signals. The device can, for example, be configured as part of an HMI, which in particular can be part of the HMI by which the ground drilling apparatus is controlled. It may be provided that the device is at least partially identical to the control system of the ground drilling apparatus for the introduction of the borehole. It is possible that a functional connection involves a direct exchange of signals and/or data; in an alternative or additional configuration, a functional connection can involve an indirect exchange of data via a memory or buffer, which may be configured as a cloud, for example.

In a preferred embodiment, the device has access to a memory in which the bending radius of the section of the drill string is assigned to a location in the borehole. By storing the data, it can be determined that, for example, when the drill string is pulled out, the drill string no longer has a bending radius below a critical threshold, in particular the minimum permissible bending radius. The intervention—for example by reducing the load through appropriate setting of parameters on the ground drilling apparatus—can be stopped and the drill string can be pulled out of the ground with parameters increased again. Furthermore, rod sections in the drill string that have been subjected to increased stress with a corresponding bending radius can be stored and/or marked separately when being pulled out.

In a preferred embodiment, an output device functionally connected to the device is provided, which is configured to issue a warning concerning the magnitude of the bending radius of the section of the drill string at an output device in order to intervene on the ground drilling apparatus.

In a preferred embodiment, an input device functionally connected to the device is provided, which is configured to query an input by means of which the warning can be acknowledged and, if the acknowledgment has been successful, to intervene on the ground drilling apparatus to further introduce the borehole.

In a preferred embodiment, a modification device is provided, which modifies the borehole, which is in particular planned, and brings about a reversal of the introduction movement towards the starting location, in particular a, especially at least partial, pulling out of the drill string and the modified borehole is introduced to the target location from a location of the borehole closer to the starting location.

In a preferred embodiment, a display device functionally connected to the device is provided, which can display one or more suggestions concerning the magnitude of parameters of the operation of the ground drilling apparatus that can be used to introduce the borehole depending on the magnitude of the bending radius of the section of the drill string and/or a functional connection of the device to the ground drilling apparatus is provided, which is configured to set parameters of the ground drilling apparatus that are used to introduce the borehole depending on the magnitude of the bending radius of the section of the drill string.

In a preferred embodiment—provided that the alternative of functional connection with the display device is included—an input device is provided which is configured to query the selection of the suggestion or multiple suggestions. The selected settings can be used for further introduction of the borehole on the ground drilling apparatus.

In a preferred embodiment, a determination device functionally connected to the device is provided, which is configured to determine the magnitude of the parameters by means of a calculation, an estimation and/or using artificial intelligence.

The invention also provides a computer-readable storage medium which includes a sequence of instructions for controlling a device, in particular a device described in the scope the description for carrying out the method described in the scope of the description in conjunction with a ground drilling apparatus. Since ground drilling apparatuses have computers for controlling them, the method described above can be carried out by feeding a computer program, which may be located on the computer-readable storage medium, into the computer of the ground drilling apparatus when required. For example, it is possible to “upgrade” a ground drilling apparatus with a computer-readable storage medium that is read by the computer of the ground drilling apparatus, thus providing the operator with added value that was previously not considered possible.

The invention also provides a ground drilling apparatus with a device described in the scope of this description, which delivers the aforementioned added value.

The invention also provides a ground drilling apparatus with a computer-readable storage medium described in the scope of the description.

The term “comprise” encompasses, within the meaning of the description, both the inherent meaning of the term, that further elements may be provided in addition to the elements mentioned (non-exhaustive list), but also the meaning that the term “comprise” is used synonymously with “consist of” or “formed of.”

The term “approximately” in the context of numerical data includes, within the meaning of the description, not only the specifically stated number but also deviations of +/−10% from the specifically stated numerical value, which may result, among other things, from manufacturing with a tolerance.

Statements regarding the different aspects concerning the method, the device, the ground drilling apparatus and the computer-readable storage medium are to be understood as complementary to each other, whereby statements concerning one aspect also apply to embodiments of another of the three aspects and are thus also disclosed for another of the aspects. By means of the method steps, together with the statements about the device, structural or physical embodiments are also disclosed, such as how the method steps can be carried out using the device, and conversely, a description of the physical design can also reveal method steps.

The above statements, like the following description of exemplary embodiments, do not constitute a waiver of particular embodiments or features.

### FIGURES

In the following, the invention will be explained in greater detail with reference to an embodiment illustrated in the drawings.

In the drawings:

FIG. 1 shows a ground drilling apparatus with a drill string in a schematic representation during the pushing introduction of the drill string; and

FIG. 2 shows the ground drilling apparatus according to FIG. 1, wherein the drill string was inserted further by extension with further rod sections.

### DESCRIPTION OF THE FIGURES

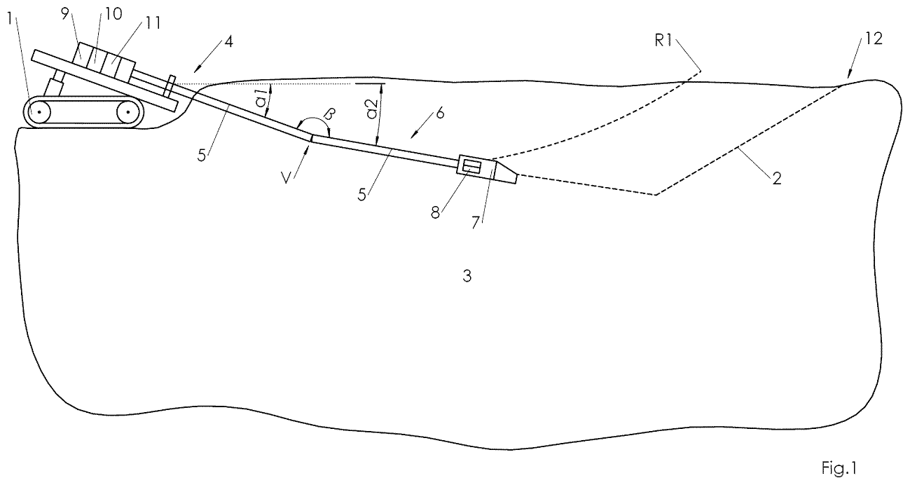

FIG. 1 shows a schematic representation of a ground drilling apparatus 1 which can introduce a borehole 2 into the ground 3. In the embodiment shown in FIG. 1, a pilot bore is created between a starting location 4, where the ground drilling apparatus 1 is positioned, and a target location 5, where the borehole 2 is to emerge from the ground 3.

To introduce the borehole 2 shown in dashed lines in FIG. 1, a drill string 6 comprising rod sections 5 is first moved by pushing through the ground drilling apparatus 1.

FIG. 1 schematically shows that the drill string 6 comprises two rod sections 5 which are connected to each other at the point marked V. At the front end of the drill string 6, spaced apart from the ground drilling apparatus 1, a drill head 7 is provided, which in the illustrated embodiment comprises a probe 8 by means of which, in conjunction with a referencing system, the drill head 7 can be located three-dimensionally after each drilling operation. The course of the introduced borehole 2 can be determined by means of the drill string 6 still located in borehole 2.

A device 11 is provided which, in the embodiment shown in the figures, is part of the ground drilling apparatus 1.

Essentially, after each drilling operation of a rod section 5 attached to the drill string 6, the drill head 7 is located and thus the course of the drill string 6, which should essentially correspond to the planned borehole 2, is determined. The determined location of drill head 7 is transmitted to device 11. The actual course of the introduced borehole 2 results from the course of the drill string 6.

FIG. 1 shows that a respective bending radius R1 can be determined for sections of the drill string 6 from the course of the determined drill string 6, which is compared with a threshold value that corresponds to the minimum permissible bending radius. Provided that the determined bending radius R1 of the section of the drill string 6 does not fall below the threshold value, no intervention needs to be carried out on the ground drilling apparatus 1.

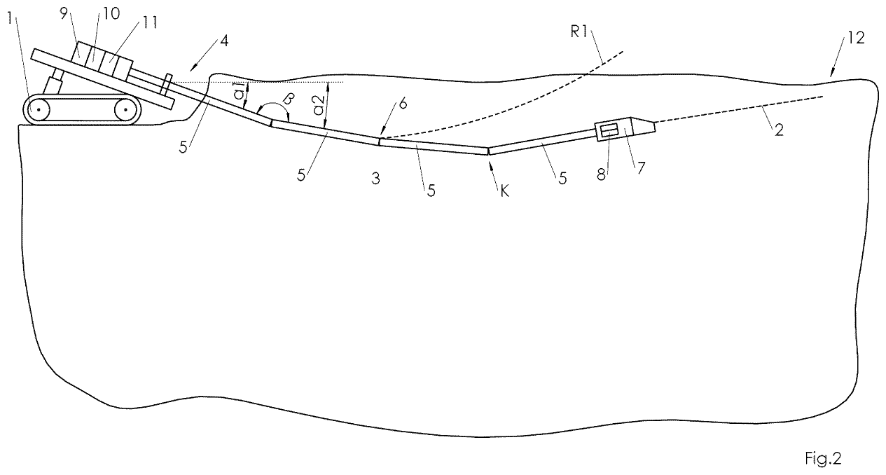

In FIG. 2, four rod sections 5 are inserted into the ground 3 and a bending radius is determined at location K which is less than the threshold value for the minimum bending radius. Now, an intervention can be carried out on the ground drilling apparatus 1, whereby a variety of options can be provided, which can be implemented selectively.

The ground drilling apparatus 1 has an output device 9 which provides information about the presence of a deviation below a minimum bending radius. The ground drilling apparatus 1 can be equipped with an input device 10 with which an operator can acknowledge the presence of a minimum bending radius in the drill string 6 in the sense of a safety query.

In the embodiment shown in the figures, it is also or alternatively possible, in particular by means of the output device 9, to suggest a change to one or more parameters for the introduction of the borehole 2 to the operator, which the operator can select in particular by means of an input at the input device 10.

Alternatively or additionally, at least temporarily, it is possible for the device 11 to automatically control parameters for introducing the borehole 2 of the ground drilling apparatus 1.

1. A method for intervening on a ground drilling apparatus which is configured to introduce a borehole by moving a drill string comprising rod sections from a starting location to a target location, wherein
the method comprises the method step:
determining a bending radius of a section of the drill string during the introduction of the borehole,
characterized in that
the ground drilling apparatus is intervened on depending on the magnitude of the bending radius of the section of the drill string during the introduction of the borehole.

2. The method according to claim 1, characterized in that
the bending radius of the section of the drill string is assigned to a location in the borehole.

3. The method according to claim 1, characterized in that
the intervention on the ground drilling apparatus includes issuing a warning concerning the magnitude of the bending radius of the section of the drill string at an output device.

4. The method according to claim 3, characterized in that
the intervention further includes querying an input by means of which the warning can be acknowledged, and if the acknowledgment has been successful, further drilling is carried out.

5. The method according to claim 3, characterized in that
the intervention brings about a reversal of the introduction movement towards the starting location in order to introduce a modified borehole to the target location from a location of the borehole closer to the starting location.

6. The method according to claim 1, characterized in that
the intervention includes a display of one or more suggestions concerning the magnitude of parameters of the operation of the ground drilling apparatus which can be used to introduce the borehole depending on the magnitude of the bending radius of the section of the drill string
and/or
the intervention includes setting parameters of the ground drilling apparatus which can be used to introduce the borehole depending on the magnitude of the bending radius of the section of the drill string.

7. The method according to claim 6, provided the alternative of displaying one or more suggestions is included, characterized in that
an input is requested regarding the selection of the suggestion or multiple suggestions.

8. The method according to claim 6, characterized in that the magnitude of the parameters of the ground drilling apparatus for the introduction of the borehole is determined by means of
a) a calculation,
b) an estimation and/or
c) using artificial intelligence.

9. A device which is or can be functionally connected to a ground drilling apparatus, wherein the ground drilling apparatus is configured to introduce a borehole by moving a drill string comprising rod sections from a starting location to a target location, wherein
the device is configured to receive the bending radius of the section of the drill string, characterized in that
the device comprises a means which is configured to intervene on the ground drilling apparatus depending on the magnitude of the bending radius of the section of the drill string.

10. The device according to claim 9, characterized in that
i) the device has access to a memory in which the bending radius of the section of the drill string is assigned to a location in the borehole;
ii) an output device functionally connected to the device is provided, which is configured to issue a warning concerning the magnitude of the bending radius of the section of the drill string at an output device in order to intervene on the ground drilling apparatus;
iii) an input device functionally connected to the device is provided, which is configured to query an input by means of which the warning can be acknowledged and, if the acknowledgment has been successful, to intervene on the ground drilling apparatus to further introduce the borehole;
iv) a modification device is provided, which modifies in particular the planned borehole and brings about a reversal of the introduction movement towards the starting location and the modified borehole is introduced to the target location from a location of the borehole closer to the starting location;
v) a display device functionally connected to the device, on which one or more suggestions concerning the magnitude of parameters of the operation of the ground drilling apparatus can be displayed, which can be used to introduce the borehole depending on the magnitude of the bending radius of the section of the drill string
and/or
a functional connection is provided between the device and the ground drilling apparatus, which is configured to set parameters of the ground drilling apparatus that are used to introduce the borehole depending on the magnitude of the bending radius of the section of the drill string; wherein, in particular, an input device is provided which is configured to query the selection of the suggestion or multiple suggestions; and/or
vi) a determination device functionally connected to the device is provided, which is configured to determine by means of
a) a calculation,
b) an estimation and/or
c) using artificial intelligence
the magnitude of the parameters of the ground drilling apparatus for the introduction of the borehole.

11. A computer-readable storage medium comprising a sequence of instructions for controlling a device, for carrying out the method according to claim 1 in conjunction with a ground drilling apparatus.

12. A ground drilling apparatus comprising a device according to claim 9.

13. The ground drilling apparatus according to claim 12, further comprising a computer-readable storage medium.
